(19) United States
(12) Patent Application Publication
(10) Pub. No.: US 2022/0308910 A1
(43) Pub. Date: Sep. 29, 2022

(54) METHOD FOR OPERATING VIRTUAL MACHINES ON A COMPUTER SYSTEM FOR A MOTOR VEHICLE AND A COMPUTER SYSTEM OF THIS TYPE

(71) Applicant: AUDI AG, Ingolstadt (DE)

(72) Inventor: Lukas ROTTKAMP, Olching (DE)

(73) Assignee: AUDI AG, Ingolstadt (DE)

(21) Appl. No.: 17/639,244

(22) PCT Filed: Mar. 18, 2021
(86) PCT No.: PCT/EP2020/069827

§ 371 Date: Feb. 28, 2022

(30) Foreign Application Priority Data
Sep. 11, 2019 (DE) 10 2019 124 343.2

(51) Int. Cl. G06F 9/455; G06F 8/61; G06F 13/38

(52) U.S. Cl. CPC G06F 9/45558; G06F 8/61; G06F 13/385; G06F 2009/45562; G06F 2009/4557; G06F 2009/45579; G06F 2213/0042

(57) ABSTRACT

A motor vehicle includes a vehicle computer, a detection unit, an evaluation unit and a removable data storage. Detection of a motor-vehicle-related activation event causes operating system installation data stored on the data storage unit as a virtual machine to be loaded by the vehicle computer unit and the virtual machine is started. Detection of a vehicle-related deactivation event causes operating system installation data describing a current operating system state of the virtual machine to be transmitted to the data storage and/or a storage device of the vehicle computer by the vehicle computer.

### CROSS REFERENCE TO RELATED APPLICATIONS

This application is a U.S. national stage of International Application No. PCT/EP2020/069827, filed on Jul. 14, 2020. The International Application claims the priority benefit of German Application No. 10 2019 124 343.2 filed on Sep. 11, 2019. Both the International Application and the German Application are incorporated by reference herein in their entirety.

### BACKGROUND

Described below is a method for running a computer system for a motor vehicle, and to a computer system of this type for a motor vehicle.

For an occupant of a motor vehicle who is not contributing to controlling the motor vehicle, it may be of interest to use a journey in the motor vehicle to work or to play computer games. Such an option for keeping busy during a journey in the motor vehicle is also interesting for all occupants of the motor vehicle in an autonomous driving procedure. In order to use the time in the motor vehicle in this manner to work or play computer games, the occupant in question may bring along for example a mobile computing device, such as for example a laptop. As an alternative thereto, the occupant may use an on-board vehicle computing device in the motor vehicle. However, this requires the occupant to transfer the data and programs required for the activity that he wants to the fixedly installed vehicle computing device. However, such a process may be relatively time-consuming for the occupant, in particular with regard to exporting the data generated during the journey in the motor vehicle from the vehicle computing device installed in the motor vehicle to a computing device outside the vehicle, such as for example the computing device in the occupant's workplace outside the vehicle.

DE 10 2012 205 301 A1 describes a computing architecture for controlling electronic data processing in a vehicle. This computing architecture comprises a computing device having at least two virtual machines (VM), the first of which comprises a first operating system and the second of which comprises a second operating system. A virtualization layer makes it possible to be able to run the first and the second operating system in parallel on the computing device. The second operating system in this case has a higher security requirement than the first operating system, meaning that the first operating system is used as an operating system with a low security standard and the second operating system is used as a certified real-time operating system for the motor vehicle.

DE 10 2013 226 700 A1 discloses a vehicle electronics unit that has a hypervisor that provides a first and a second VM. The hypervisor secures a terminal interface assigned exclusively to the first VM. A non-secure terminal, such as for example a Universal Serial Bus (USB) data carrier, may be connected to the vehicle electronics unit at this terminal interface. Data may thus be exchanged between the first VM and the non-secure terminal via the terminal interface. In this case, the security of the second VM is not jeopardized in spite of the connection to the non-secure terminal.

### SUMMARY

Described below is way of which an occupant of a motor vehicle is able to conveniently operate a vehicle computing device in the motor vehicle.

A mobile computing device, such as for example a laptop, usually has disadvantages in comparison with a fixedly installed computing device, for example since such a mobile computing device often has less computing power in comparison with a fixedly installed computing device, has no dedicated graphics card and/or has no individual drives. In addition, such a mobile computing device always has to be carried around, for example including a power supply unit and a cable, resulting in a loss of convenience for the occupant of the motor vehicle if he wants to work in the motor vehicle or play a computer game using such a mobile computing device during a journey in the motor vehicle. However, if the occupant uses a vehicle computing device fixedly installed in the vehicle during the journey in the motor vehicle, he may have to install the programs he requires there, update them regularly and think about how to save the data generated in the motor vehicle when leaving the motor vehicle and possibly transport them to a computing device outside the vehicle. This reduces the convenience of using the vehicle computing device installed in the motor vehicle. Now, it would be possible for the occupant to load the data generated by the vehicle computing device or the data the occupant requires in the motor vehicle into a computer cloud infrastructure, that is to say into what is known as a cloud, which he accesses from the vehicle computing device, and to use them in appropriate “cloud software”. However, a data security-conscious occupant of the motor vehicle in particular has no interest in making his data and documents available to a computer cloud infrastructure operator. It therefore makes sense to provide occupant-specific operating system installation data when accessing the vehicle computing device fixedly installed in the motor vehicle for work or playing computer games using a data storage device that is not installed in the motor vehicle, which operating system installation data may be loaded from the fixedly installed vehicle computing device and then used in the motor vehicle with the aid of the vehicle computing device. It thus makes sense to run the occupant's operating system installation data as what is known as a virtual machine (VM). A VM is the name generally given to a software-based encapsulation of a computer system within an executable computer system. The VM in this case emulates the computing architecture of a computer that actually exists in hardware form or of a hypothetical computer.

The method for running a computer system for a motor vehicle is based on the fact that the computer system includes a vehicle computing device fixedly installed in the motor vehicle, an acquisition device, an evaluation device and a device that is not fixedly installed in the motor vehicle. The vehicle computing device fixedly installed in the motor vehicle processes data by way of programmable computing rules, that is, a computer. The acquisition device is for example a touch-sensitive screen of a display apparatus in the motor vehicle, by way of which an actuation of an operating element on the touch-sensitive screen through a corresponding touch of the touch-sensitive screen by an occupant of the motor vehicle is able to be acquired and provided as an actuation signal of the touch-sensitive screen. The evaluation unit is for example integrated into the acquisition device and is designed to evaluate data acquired at the acquisition device, such as for example the actuation signal. The data storage device that is not fixedly installed in the motor vehicle is for example as a Universal Serial Bus (USB) data carrier. The data storage device may therefore be carried around by the occupant of the motor vehicle and for example be coupled to the vehicle computing device via a corresponding data carrier interface in the motor vehicle interior. The data storage device may transfer operating system installation data to the vehicle computing device and/or to receive them therefrom via a communication link with the vehicle computing device. If the USB data carrier has for example been inserted into the data carrier interface, the communication link may be set up between the data storage device and the vehicle computing device. The occupant's operating system installation data are stored on the USB data carrier, by way of which operating system installation data it is possible for the operating system installation data stored on the USB data carrier to be able to be run as a VM on the hardware provided by the vehicle computing device. This is based on the possibility of transferring the operating system installation data from the data storage device to the vehicle computing device, and of correspondingly transferring data from the vehicle computing device to the data storage device by way of the communication link.

The method includes: First, a motor vehicle-related activation event is ascertained for running operating system installation data, stored on the data storage device, as a VM on the vehicle computing device. The ascertainment takes place on the basis of activation indicator data, acquired by way of the acquisition device, by way of the evaluation unit. The evaluation unit thus ascertains the motor vehicle-related activation event. The motor vehicle-related activation event may be for example actuation of an operating element serving as an activation element in order to start the running of the VM by the occupant of the motor vehicle on the touch-sensitive screen in the motor vehicle. For example, a corresponding symbol is displayed on the touch-sensitive screen in the motor vehicle, which the occupant touches with a finger of his hand and thereby actuates. The actuation of the activation element is thus considered to be a motor vehicle-related activation event. In this example, the acquired activation indicator data are signals generated by touching the activation element on the touch-sensitive screen. Ultimately, in this case, the time is established at which there is an indicator that it is desired to activate the running of the data stored on the data storage device as a VM on the vehicle computing device.

As soon as the motor vehicle-related activation event has been ascertained, the vehicle computing device receives the operating system installation data stored on the data storage device and the running of the VM is started. Thus, for example, after it has been established that the activation element for starting the running of the VM has been actuated, processes are initiated in order to run the operating system installation data stored on the data storage device as a VM by way of the vehicle computing device. Corresponding data are first of all transferred from the data storage device to the vehicle computing device via the communication link, that is to say received by the vehicle computing device, and the running of the VM is activated in response thereto. From this time on, the occupant of the motor vehicle may now work with the VM based on the operating system installation data using the hardware of the vehicle computing device installed in the motor vehicle, or for example play a computer game. No operating system installation was performed on the vehicle computing device installed in the motor vehicle, but only the operating system installation data are run as a VM on the vehicle computing device.

The occupant of the motor vehicle thus provides his own operating system installation using the data storage device. With regard to the technical implementation, use is made here for example of virtualization technology, as is already commercially available in connection with the running of VMs, such that the operating system installation data stored on the data storage device are able to be run as a VM by way of the vehicle computing device.

A motor vehicle-related deactivation event is ascertained for running the VM on the vehicle computing device. This is performed on the basis of deactivation indication data acquired by way of the acquisition device, wherein the deactivation event is ascertained by way of the evaluation unit. Actuation of a deactivation element in order to end the running of the VM on the touch-sensitive screen of the display device of the motor vehicle may be established as a motor vehicle-related deactivation event, for example. The corresponding actuation signals of the deactivation element are evaluated by the evaluation unit as deactivation indication data, such that a corresponding signal that describes the motor vehicle-related deactivation event is provided to the vehicle computing device. As soon as the deactivation event has been ascertained, the vehicle computing device transfers operating system installation data describing a current operating system state of the VM to the data storage device and/or a storage apparatus of the vehicle computing device. Thus, as soon as it has been established that for example the occupant of the motor vehicle no longer wishes to run the VM on the vehicle computing device, because for example he wants to shut down the operating system installation he is currently using by actuating the deactivation element, the current state of the previously active operating system installation is saved in the form of corresponding operating system installation data by virtue of the operating system installation data being transferred from the vehicle computing device to the data storage device and/or the storage apparatus via the communication link. After the deactivation event has been ascertained, the current state of the VM is thus saved for example on the data storage device, such that the occupant is able to continue to work or play a computer game starting from the current state of the VM, at a later point in time, for example by way of a computing device outside the vehicle in an office or at home. In order to transfer the operating system installation data describing the current state of the VM, what is known as snapshot technology may for example be used, by way of which it is possible to record and provide a virtual replica of the operating system that is used. As a result, it is also not necessary for the operating system run on the vehicle computing device installed in the motor vehicle to be shut down so that it is able to be reused at a later point in time when changing workplace, but it is even possible to use or run the VM on the computing device outside the vehicle while continuing to run it on the vehicle computing device. Ultimately, the transfer of the operating system installation data describing the current operating system state of the VM provides a synchronization possibility between the VM in the motor vehicle and an operating system run outside the vehicle.

When storing the operating system installation data describing the current operating system state of the VM on the storage apparatus of the vehicle computing device, if the occupant only wants to continue using the VM in a future journey in the motor vehicle, for example because he wants to continue working only then, a possibly time-consuming transfer of the corresponding operating system installation data to the data storage device may be avoided by virtue of the data required for continued work with the VM being stored in the motor vehicle itself, specifically in the storage apparatus of the vehicle computing device. This is because it is sometimes the case that, in the time between the deactivation event and reactivation of the operating system installation data to continue working or continue playing in the motor vehicle, no data change at all and therefore no changed operating system installation data have to be transferred from the data storage device to the vehicle computing device. This is the case for example when an occupant leaves a vehicle in the evening and gets back into this vehicle the next morning and triggers a new activation event there without having worked with the VM elsewhere in the meantime. It is therefore advantageous, in this case, to allow the occupant's operating system installation data to be stored in the motor vehicle, specifically storage on the storage apparatus of the vehicle computing device. After the occupant exits as a deactivation event, the operating system installation data describing the current operating system state of the VM may therefore be stored at least temporarily in the storage apparatus. Provision may be made here for the data stored there to be automatically erased if the data have not been accessed for a predefined period of time, for example one day, two days, three days or one week and/or if storage space in the storage apparatus drops below a predefined minimum storage space value, that is to say becomes scarce. The storage apparatus may thus be provided in the form of what is known as a cache. Upon a next activation event, a check is then first carried out to determine whether new operating system installation data actually have to be transferred from the data storage device, or whether all or at least some of the required operating system installation data may be loaded from the storage apparatus. An activation and/or deactivation time of the VM may thereby be reduced in comparison with loading and storing the operating system installation data on the data storage device. However, it is not possible to continue working with the current state of the VM outside the motor vehicle when the operating system installation data are only stored in the storage apparatus.

The operating system installation data may thus be synchronized with the data storage device and/or the storage apparatus. Ultimately, the synchronization may take place between the vehicle computing device and the data storage device, for example in the form of what is known as cloud synchronization. However, as an alternative or in addition thereto, it is possible to provide intelligent synchronization of the vehicle computing device with the loaded operating system installation data for the storage apparatus in the motor vehicle. The storage apparatus may then continue to keep the operating system installation data ready for the next activation in the manner of a cache, even after the use of the VM has ended and the motor vehicle has been deactivated.

Since the operating system installation data themselves are usually so large that it takes several minutes to completely transfer them to the data storage device and/or the storage apparatus, not all of the operating system installation data are always transferred, but rather only the operating system installation data describing the current operating system state of the VM. It is namely advantageous if not all of the operating system installation data are always transferred again, but only some of the data that have changed. Such data are referred to here as the operating system installation data describing the current operating system state of the VM. As an alternative thereto, it is possible for all of the operating system installation data to be transferred.

One advantage of the method is that an occupant of the motor vehicle is able to use his own operating system installation, as he could also do on a mobile computing device he brings along, but at the same time has all the advantages of a computing device fixedly installed in the motor vehicle in comparison with a mobile computing device. This allows the occupant to operate and use the vehicle computing device in a convenient manner. On the one hand, the mobile computing device does not have to be carried around; instead, it is sufficient to carry around the data storage device in the form of a USB data carrier, for example. As an alternative thereto, a computer cloud infrastructure is possible, for example, as data storage device, such that for example the occupant does not have to take any physical device at all with him into the motor vehicle in order to be able to perform the described method. As a result, wireless mobile working or playing computer games during a trip in a motor vehicle may ultimately be made possible, in particular through the described transfer of the operating system installation data describing the current operating system state of the VM to the data storage device. The occupant may simply sit in the motor vehicle, for example a taxi, and use the communication link to the selected data storage device there to immediately start his own operating system installation without having to transport, open, connect and/or boot the mobile computing device beforehand. This makes it possible to run a dedicated operating system on a vehicle computing device fixedly installed in the motor vehicle in a convenient manner with little effort for the occupant.

In one advantageous embodiment, provision is made, after the deactivation event has been ascertained and the operating system installation data describing the current operating system state of the VM have been transferred, for the running of the VM to be ended. Whenever the described synchronization between the operating system installation data used in the motor vehicle and the operating system installation data stored on the data storage device takes place, that is to say whenever as soon as the deactivation event has been ascertained, the running of the VM may thus also be completely deactivated by virtue of the running of the VM being ended by way of the vehicle computing device. This for example reduces energy consumption in the motor vehicle, since the VM is only ever run when this is actually desired by the occupant of the motor vehicle. In this case, the deactivation event represents the occupant's desire to end the running of the VM, in response to which the running of the operating system installation data is shut down completely by way of the vehicle computing device. This also ensures that, for example, the VM is not able to be used by third parties who for example get into the motor vehicle and may continue to access the occupant's personal user installation data despite the deactivation event on the part of the occupant. This ultimately provides a particularly convenient way of ending the described running of the VM by way of the vehicle computing device, since it takes place automatically after the deactivation event.

According to a further embodiment, provision is made for virtualization software to be provided on the vehicle computing device, by way of which the received operating system installation data are run as a VM. This virtualization software is thus designed to emulate a software object with a similar object of the same type by way of an abstraction layer. As a result, a virtual device or a virtual service, such as the virtual operating system here, is generally able to be generated based on the provided operating system installation data. This makes it possible to run the operating system provided on the data storage device using the operating system installation data as a VM within an operating system of the vehicle computing device installed in the motor vehicle. The virtualization software is in this case stored on the vehicle computing device, such that provision may be made for the operating system installation data to be stored in encrypted form on the data storage device and be able to be decrypted by the vehicle computing device and made usable thereon only by way of a corresponding authorization provided by the occupant or a decryption option stored in the operating system of the vehicle computing device. This ensures that only the operating system installation data actually desired by an occupant of the motor vehicle are processed by the vehicle computing device such that it runs them as a VM. In this context, it is additionally possible for the operating system installation data, which are run as a VM, to be transferred from the data storage device to the vehicle computing device either as a coherent data packet or as multiple individual data packets that are each encrypted and sent separately from one another, for example, and ultimately to be run as a VM using the virtualization software. Ultimately, the virtualization software allows uncomplicated, direct running of the VM on the vehicle computing device.

One particularly advantageous embodiment makes provision for data synchronization software to be provided on the vehicle computing device, by way of which data synchronization software the operating system installation data describing the current operating system state of the VM are generated in order to be transferred to the data storage device and/or the storage apparatus of the vehicle computing device. The above-described “snapshot” of the operating system state of the VM is thus taken using the data synchronization software, in order to store this on the data storage device. Typical and common methods may in this case be used, these being able to be provided to and used by the vehicle computing device by the data synchronization software. This allows the operating system, which is used as a VM on the vehicle computing device, to be saved in the respective current operating system end state and provided for subsequent use on the same and/or another computing device. This makes it possible to conveniently switch between running the VM by way of the vehicle computing device installed in the motor vehicle and any other computing device that the occupant of the motor vehicle wishes to use.

A further embodiment makes provision for the operating system installation data describing the current operating state of the VM to be transferred during the running of the VM at at least one predefined data synchronization time. The at least one predefined data synchronization time may be predefined, for example, on the basis of a predefined time interval since the VM started running. Provision may be made for example for such a data synchronization time to be reached every ten minutes from the start of running of the VM, and thus for the described backup copy of the current operating state of the VM in the form of the operating system installation data describing the current operating system state of the VM to be able to be transferred to the data storage device and thus to be able to be saved thereby every ten minutes. The data may thus be synchronized continuously, for example by applying the data synchronization software, even while the VM is running on the vehicle computing device. As a result, it is possible to access a current operating system state of the VM even without an ascertained deactivation event. This supports the occupant with the described possible seamless transition from running the VM on the vehicle computing device installed in the motor vehicle to operating the current operating system on another computing device of his choice. For advantageous additional protection of the operating system state data, intermediate synchronizations of the respective current operating state of the VM may thus be performed and stored on the data storage device.

Furthermore, in one embodiment of the method, provision is made for the acquisition device to acquire, as activation indicator data, data that describe at least one of the following situations: actuation of an activation element in order to start running of the VM, coupling of the data storage device containing the stored operating system installation data to a data storage device interface of the motor vehicle, a successful login process with a predefined user account, unlocking of a door-locking device of the motor vehicle, opening of a vehicle door of the motor vehicle when the VM is not running and/or occupancy of a vehicle seat in the motor vehicle.

As already described above, the actuation of the activation element for starting running of the VM on the display device in the motor vehicle, which may be in the form of a touch-sensitive screen, may thus be established as an activation event, for example. The activation element may be provided, as an alternative or in addition to an element displayed on the touch-sensitive screen, as an operable button, rotary pushbutton switch and/or operable knob in the motor vehicle, such that actuation of such an actuation element may ultimately cause the VM to start running in the form of corresponding activation indicator data. As an alternative or in addition thereto, a data storage device interface of the motor vehicle may include a sensor as acquisition device, which establishes insertion or connection of the data storage device, for example in the form of a USB data carrier, and uses such an established coupling signal to detect the coupling of the data storage device to the data storage device interface. In addition, a check is performed to determine whether there are operating system installation data stored on the inserted or connected data storage device. If this is the case, the coupling of the data storage device containing the stored operating system installation data to the data storage device interface of the motor vehicle is considered to be an activation event. As an alternative or in addition thereto, a component of the vehicle computing device may be used as acquisition device to check whether a login process by an occupant of the motor vehicle with a predefined personal user account was successful, and such a successful login process is assessed as activation event. The user account may be stored in the motor vehicle, on a computer cloud infrastructure and/or on an external server device, for example of a vehicle manufacturer, and may be protected for example by way of a password request. The login process is assessed as successful only if the password check is successful.

As an alternative or in addition thereto, the acquisition device may be a sensor device of the motor vehicle, for example a sensor that detects the unlocking of a locking device of the vehicle doors of the motor vehicle and/or establishes opening or closure of the respective vehicle door itself. For example, if the VM is currently not running, opening the vehicle door may serve as an indicator that the occupant is getting into the motor vehicle and consequently wants the VM to start running as soon as possible. As an alternative or in addition thereto, entry of the occupant may already be identified when the door-locking device of the motor vehicle is unlocked, such that this may already be considered to be a motor vehicle-related activation event that indicates that the occupant wants the VM to start running on the vehicle computing device in the near future. As an alternative or in addition thereto, a sensor device of a vehicle seat, such as for example a weighing sensor installed in the vehicle seat, may be used to identify the seat occupancy of the vehicle seat by the occupant, and to consider this to be a corresponding activation event. The imminent or already detected presence of an occupant in the motor vehicle may thus already be assessed to the effect that running of the VM should be initiated. This has the advantageous effect that the occupant, while he is in the motor vehicle, is able to access the already running VM at any time in a timely manner and with little waiting time.

However, the prerequisite for this is always that the communication link between the data storage device and the vehicle computing device is present. If for example unlocking of a door-locking device of the motor vehicle is detected, but no communication link is established between the data storage device and the vehicle computing device, for example because the USB data carrier is not positioned in the corresponding data carrier interface of the vehicle computing device, the activation event is not ascertained because the corresponding operating system installation data are not provided by the data storage device. It is also relevant here that the activation indicator data always describe a motor vehicle-related activation event, such as the actuation of the activation element of the display device in the motor vehicle, but also the various situations relating to the occupant getting into the motor vehicle. All of these activation indicator data thus describe situations that have a clear reference to the motor vehicle, by way of whose vehicle computing device the occupant's operating system installation data are intended to be run as a VM. Overall, this makes it possible to automatically activate the VM, that is to say to automatically load the operating system installation data stored on the data storage device and then to start running the VM by way of the vehicle computing device. Provision may be made in this case for a large number of possible indicators, such that it may be assumed, with a high degree of probability, that when the activation indicator data are acquired and the motor vehicle-related activation event is then ascertained, it may actually be expected that the occupant wants to run the VM by way of the vehicle computing device. This allows particularly convenient running of the operating system installation data as a VM on the vehicle computing device. The activation events desired by the occupant may in this case be specified by the occupant in the motor vehicle and may thus be predefined in a user-specific manner. It is thus possible to take into consideration personal preferences with regard to the detected activation event, and, thus, the running of the VM is initiated only if this is actually currently or presently desired by the occupant. In this case, for example, a stored earlier behavior of the occupant in the motor vehicle may be used, on the basis of which it is known that the occupant always starts to work using the VM during journeys in the motor vehicle in the morning immediately after he has got into the motor vehicle. Despite the automatic startup, it is thus possible to run the VM in the motor vehicle in an energy-saving manner, since starting up of the VM without indicators of an activation request from the occupant is avoided.

In addition, one embodiment makes provision for the acquisition device to acquire, as deactivation indicator data, data that describe at least one of the following situations: actuation of a deactivation element in order to end running of the VM, a successful logout process with a predefined user account, non-actuation of an operating element for running the running VM for a predefined minimum period of time, locking of a door-locking device of the motor vehicle, opening of a vehicle door of the motor vehicle when the VM is running and/or non-occupancy of a vehicle seat in the motor vehicle when the VM is running. In the same way as actuating the activation element, for example on the touch-sensitive screen, a predefined deactivation element may be provided using the touch-sensitive screen, wherein actuation of the deactivation element express a desire to end the running of the VM. As an alternative or in addition thereto, a component of the vehicle computing device may be used as acquisition device to check whether a logout process by the occupant of the motor vehicle with the predefined personal user account was successful, and such a successful logout process is assessed as activation event. The user account may be stored in the motor vehicle, on the computer cloud infrastructure and/or on the external server device, for example of the vehicle manufacturer. In contrast, however, provision may be made, in addition or as an alternative, whenever a predefined minimum period of time of non-actuation of the VM is established, for this to be considered to be a deactivation event, and for the operating system installation data describing the current operating system state of the VM to at least be transferred to the data storage device in response thereto. This minimum period of time may for example be ten minutes or more, such that, if the VM is not actuated in any way, this behavior of the occupant is assessed as a deactivation request and the described transfer of the operating system installation data and, if necessary, the ending of the VM are initiated in response thereto. This procedure is suitable for example for energy-saving running of the operating installation data as a VM on the vehicle computing device, since there is a prompt response to an inactive phase of the user.

In the same way as the situations described above in which the motor vehicle-related activation event may ultimately be inferred from the unlocking of the door-locking device, the opening of the vehicle door and/or the occupancy of the vehicle seat, when a door-locking device of the motor vehicle is locked, for example when the occupant leaves the motor vehicle, when the vehicle door is opened when the VM is currently running and/or when the vehicle seat in the motor vehicle is detected as not being occupied when the VM is currently running, a desired deactivation of the VM may accordingly be concluded. These situations may therefore each be interpreted as an indicator for the motor vehicle-related deactivation event. Based on one or more of these situations, it is thus possible to conclude that the occupant has left the motor vehicle, which is evaluated as a triggering event for deactivating the running of the VM. Since the current operating system state of the data storage device is always saved automatically in these situations, this ensures that, even if for example time is short and the occupant is not able to manually deactivate the running of the VM, the occupant is able to access the last saved current operating system state of the VM on another computing device if he wants to. This results in an additional increase in convenience for the occupant of the motor vehicle with regard to a seamless transition between running the operating system installation data as a VM on the vehicle computing device and using precisely this operating system on a respective further computing device.

In an additional embodiment, provision is made for sensor data describing an occupant of the motor vehicle to be acquired by way of a sensor device of the motor vehicle. This sensor device of the motor vehicle is for example an interior camera or a sensor that identifies a presence of a vehicle key in the motor vehicle. The acquired sensor data are evaluated by way of the evaluation unit using an identification criterion in order to generate an authorization signal. The identification criterion includes for example rules that predefine which person, that is to say which potential occupant of the motor vehicle, has a certain appearance, that is to say certain physical features able to be taken from the sensor data of the interior camera, and/or is linked to a certain vehicle key in order to identify the person. In addition, these rules may predefine whether the identified person is generally authorized to use an operating system provided by the data storage device as a VM in the motor vehicle by way of the vehicle computing device. If for example it is established, on the basis of the vehicle key and/or using an evaluation of the image data of the occupant as provided by the interior camera, that the occupant is a specific person who is additionally authorized to use the vehicle computing device to run the operating system he has brought along as a VM, the corresponding authorization signal is generated. Ultimately, the setting up of the communication link between the data storage device and the vehicle computing device is authorized or prevented by the vehicle computing device depending on the generated authorization signal. For example, a corresponding user account of the occupant may be stored in the motor vehicle and/or stored in a computer cloud infrastructure for access from the motor vehicle, such that data from the interior camera and/or vehicle key data may be used to check whether the person whose user account is stored in the motor vehicle is actually an occupant of the motor vehicle at a current time, whereupon running of the operating system installation data provided by this occupant as a VM in the motor vehicle is authorized. This provides an additional level of security, since unambiguous and reliable identification of the occupant and potential user of the VM is achieved based on the sensor device provided in the motor vehicle.

In addition, one embodiment makes provision for the vehicle computing device to include a hypervisor, such that multiple VMs are able to be run on the vehicle computer at the same time. A hypervisor, which is often alternatively referred to as a virtual machine monitor (VMM), constitutes an abstraction layer between the hardware that is actually present, that is to say the vehicle computing device installed in the motor vehicle, and other operating systems to be installed, that is to say the operating systems provided on the respective data storage devices using the operating system installation data. Such a hypervisor makes it possible to define a virtual environment that is used independently of the hardware that is actually present in the vehicle computing device for the installation of guest operating systems, that is to say the installation of the respective operating system installation data as a VM. Multiple VMs running at the same time are of interest whenever the vehicle computing device is provided with respective operating system installation data by multiple data storage devices. If the motor vehicle is for example a taxi, it may be the case that multiple passengers of this taxi want to use the hardware of the vehicle computing device to work and/or play computer games at the same time using a respective VM. This is then possible using the hypervisor of the vehicle computing device, since multiple VMs are able to be run simultaneously by the vehicle computing device. Ultimately, only one vehicle computing device fixedly installed in the motor vehicle is required for this, this being able to be shared by the multiple occupants. This results in numerous usage options for a motor vehicle, for example for a taxi and/or a shuttle, in which multiple people are able to use their VM at least partially at the same time. In the case of motor vehicles used by multiple people, for example, this increases the respective convenience for the individual occupants of the motor vehicle with regard to one possibility of private work and/or playing computer games during a journey in this motor vehicle.

The computer system for a motor vehicle includes a vehicle computing device fixedly installed in the motor vehicle, an acquisition device, an evaluation unit and a data storage device that is not fixedly installed in the motor vehicle. The data storage device is designed to transfer operating system installation data to the vehicle computing device and/or to receive them therefrom via a communication link with the vehicle computing device. The evaluation unit is designed to ascertain a motor vehicle-related activation event for running operating system installation data stored on the data storage device as a VM on the vehicle computing device on the basis of activation indicator data acquired by way of the acquisition device, and a motor vehicle-related deactivation event for running the VM on the vehicle computing device on the basis of deactivation indication data acquired by way of the acquisition device. The vehicle computing device is designed to receive the operating system installation data stored on the data storage device and to start running the VM as soon as the motor vehicle-related activation event has been ascertained. In addition, the vehicle computing device is designed to transfer operating system installation data describing a current operating system state of the VM to the data storage device and/or a storage apparatus of the vehicle computing device as soon as the motor vehicle-related deactivation event has been ascertained. The embodiments introduced in connection with the method, and the advantages thereof, correspondingly apply, where applicable, to the computer system for a motor vehicle. For this reason, the corresponding developments of the computer system will not be described again here.

In one advantageous embodiment of the computer system, provision is made for the data storage device to be designed as a mobile electronic appliance and/or as a storage unit arranged outside the motor vehicle. If the data storage device is designed as a mobile electronic appliance, it is in particular designed as a USB data carrier, hard drive, memory card and/or mobile telephone of the occupant. The occupant's operating system installation data are then stored on one of these mentioned mobile electronic appliances. In addition, the corresponding mobile electronic appliance is designed to set up and maintain the communication link with the vehicle computing device. However, if the data storage device is designed as a storage unit arranged outside the motor vehicle, it is designed in particular as a storage unit of a computer network, as a storage unit of a server device and/or as a storage unit of the computer cloud infrastructure. The corresponding operating system installation data are then available for example on an external server device and thus ultimately, for example, on a cloud platform, and may be transferred therefrom to the motor vehicle via a wireless communication link between the vehicle computing device and the storage unit arranged outside the motor vehicle as data storage device. This makes it clear that the data storage device is not fixedly installed in the motor vehicle, but rather may be arranged only temporarily therein as a mobile electronic appliance, for example. However, as an alternative or in addition thereto, it is possible for the data storage device not to be arranged as a physical appliance in the motor vehicle at all, but merely to be provided as a storage unit that is arranged outside the motor vehicle and with which there is a wireless communication link. This provides numerous different options for the occupant of the motor vehicle as to how he would like to provide the operating system installation data for the vehicle computing device during his journey in the motor vehicle.

The communication link between the vehicle computing device and the data storage device may for example be provided in the form of a wireless link, for example via a wireless local area network (WLAN), a Bluetooth link and/or a mobile data network, for example based on the Long Term Evolution (LTE), Long Term Evolution Advanced (LTE-A) or Fifth Generation (5G) mobile radio standard. In the case of the data storage device as a USB data carrier, hard drive, memory card and/or mobile telephone, as an alternative or in addition thereto, provision may be made for a wired communication link, for example implemented via the data carrier interface or a corresponding other appliance interface of the vehicle computing device in the motor vehicle.

One embodiment of the computer system makes provision for the computer system to include a display device, an actuation device, a microphone device and/or a loudspeaker device. This respective additional device is designed to be actuated by the vehicle computing device while the VM is running. The contents of the VM may therefore appear for example on the display device of the motor vehicle, which may be in the form of a touch-sensitive screen arranged for example in the area of a center console of the motor vehicle. The actuation device for this display device may likewise be predefined as a unit that is fixedly installed in the motor vehicle. In addition, for example, the loudspeaker device of the motor vehicle may be used to process voice signals, and the microphone device of the motor vehicle may be used to output audio signals. In addition to using the vehicle computing device installed in the motor vehicle, at least one further component of the motor vehicle may thus be used in order to provide a convenient and functionally comprehensive infrastructure for the VM run in the motor vehicle. Using the already mentioned interior camera of the motor vehicle, it is additionally possible to support and provide gesture-based control of the VM. No additional components of the computer system to be installed in the motor vehicle are therefore necessary in order to be able to provide a full range of functions of the running VM based on the vehicle computing device fixedly installed in the motor vehicle.

An additional embodiment of the computer system makes provision for the vehicle computing device to be designed as a computing device that is decoupled from a control device of the motor vehicle. The vehicle computing device thus makes provision, for example for security reasons with regard to possible manipulation of vehicle control software of the motor vehicle, for the VM to be run only on a vehicle computing device specially provided and not on the vehicle computing device, which additionally provides and executes all of the control software components required for example for fully autonomous driving of the motor vehicle. This ensures, in a technically simple manner, that the control software of the motor vehicle itself cannot be manipulated by running the VM accordingly.

As an alternative thereto, it is possible for the vehicle computing device to be contained in the computing device that includes the control device of the motor vehicle. It is therefore possible for only one vehicle computing device to be provided in the motor vehicle, this being both designed to run the occupant's operating system installation data as a VM and designed and used to control the motor vehicle. However, even in this case, appropriate protection mechanisms make it possible to ensure that the VM is run by way of the vehicle computing device, which is advantageous per se for the operation of the motor vehicle. Corresponding solutions are disclosed, for example, in the two documents cited above, DE 10 2012 205 301 A1 and DE 10 2013 226 700 A1.

The motor vehicle may include a motorized vehicle, such as a passenger car or truck, or a minibus or motorcycle.

Described below is the vehicle computing device and/or the evaluation unit for the computer system. The vehicle computing device and/or the evaluation unit each have a processor device that perform the method. The processor device may have at least one microprocessor and/or at least one microcontroller and/or at least one FPGA (Field-Programmable Gate Array) and/or at least one DSP (Digital Signal Processor). Furthermore, the processor device may have program code, which is designed to carry out the embodiment of the method upon execution by the processor device. The program code may be stored in a data memory of the processor device.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic illustration of a computer system for a motor vehicle; and

FIG. 2 is a schematic illustration of a signal flow graph for a method for running a computer system for a motor vehicle.

### DETAILED DESCRIPTION

Reference will now be made in detail to the preferred embodiments, examples of which are illustrated in the accompanying drawings, wherein like reference numerals refer to like elements throughout.

In the exemplary embodiments, the described components of the embodiments each represent individual features that should be considered independently of one another and be developed in each case independently of one another. The disclosure is therefore also intended to include combinations of the features of the embodiments other than those illustrated. Furthermore, the described embodiments may also be supplemented by further features that have already been described.

In the figures, identical reference signs each denote elements of identical function.

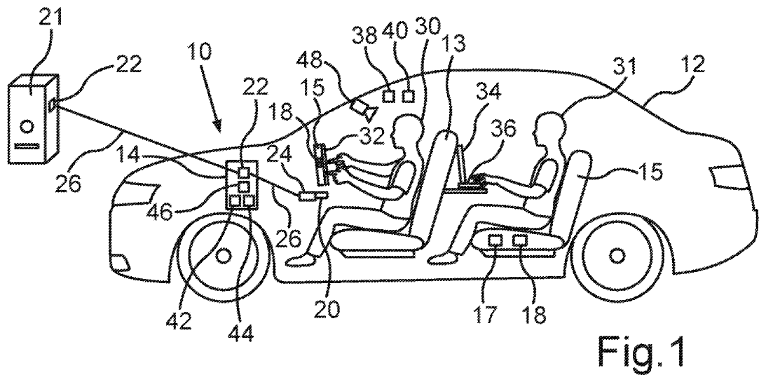

FIG. 1 outlines a computer system 10 for a motor vehicle 12. The computer system 10 includes a vehicle computing device 14 fixedly installed in the motor vehicle 12, this being for example an on-board computer of the motor vehicle 12. In addition, the computer system 10 includes two acquisition devices 16, 17, each of which is assigned an evaluation unit 18. The computer system 10 furthermore includes two data storage devices 20, 21 that are each not fixedly installed in the motor vehicle 12. A respective communication link 26 is set up between a communication interface 22 of the vehicle computing device 14 and the respective data storage device 20, 21. Here, the data storage device 20 is designed as a Universal Serial Bus (USB) data carrier that is coupled to the communication interface 22 of the vehicle computing device 14 by way of a data storage device interface 24 via the communication link 26. In contrast, the data storage device 21 is designed as a storage unit of a computer cloud infrastructure, that is to say as a cloud platform, which in turn has its own communication interface 22, by way of which the communication link 26 is set up between the data storage device 21 and the vehicle computing device 14. The data storage device 20, 21 is designed to transfer operating system installation data to the vehicle computing device 14 and/or to receive them therefrom via the communication link 26.

There are two occupants 30, 31 in the motor vehicle 12. The occupant 30 is in this case sitting on a front seat 13 of the motor vehicle 12, and the occupant 31 is sitting on a rear seat 15 of the motor vehicle 12. The acquisition device 16, which is designed as a touch-sensitive screen 32, is located within sight and reach of the occupant 30. On this touch-sensitive screen 32, the occupant 30 may for example actuate an activation element in order to start running of a virtual machine (VM) based on the operating system installation data stored on the data storage device 20. Likewise, the occupant 30 may give a signal to end the running of the VM by way of the vehicle computing device 14 through corresponding actuation of a deactivation element on the touch-sensitive screen 32. If one of these scenarios is the case, the corresponding actuation on the touch-sensitive screen 32 is acquired by way of the acquisition device 16 and the corresponding actuation is evaluated as activation indicator data or as deactivation indicator data by way of the evaluation unit 18.

The occupant 31 is seated and within reach of a display device 34 of the motor vehicle 12, which is just a screen. There is also an actuation device 36, designed in the form of a keyboard, in front of the occupant 31. The occupant 31 is able to work and/or play a computer game by way of the display device 34 and the actuation device 36 when running a corresponding operating system on the vehicle computing device 14 during a journey in the motor vehicle 12. As an alternative or in addition to the keyboard outlined here, the actuation device 36 may be designed as a button, rotary pushbutton switch and/or knob. The occupant 31 who is sitting on the rear seat 15 in the motor vehicle 12 is also on a seat in which a weighing device is integrated as acquisition device 17. Occupancy of the rear seat 15 of the motor vehicle 12 may be established using this weighing device as acquisition device 17.

The touch-sensitive screen 32, the display device 34 and the actuation device 36 are each contained in the computer system 10. The computer system 10 additionally includes a microphone device 38 and a loudspeaker device 40 of the motor vehicle 12. All of the components mentioned, that is to say the touch-sensitive screen 32, the display device 34, the actuation device 36, the microphone device 38 and the loudspeaker device 40, are each designed to be actuated by the vehicle computing device 14.

The vehicle computing device 14, which is fixedly installed in the motor vehicle 12, has virtualization software 42, by way of which the operating system installation data provided by the data storage device 20, 21 via the communication link 26 may be run as a VM. The vehicle computing device 14 furthermore has data synchronization software 44, by way of which operating system installation data describing a current operating system state of the VM may be generated in order to be transmitted to the data storage device 20, 21. The vehicle computing device 14 additionally includes a hypervisor 46, so that multiple VMs are able to be run on the vehicle computing device 14 at the same time if the vehicle computing device 14 is provided with respective operating system installation data by multiple data storage devices 20, 21. The occupants 30, 31 may thus run respective VMs on the vehicle computing device 14 at the same time.

The motor vehicle 12 additionally has a sensor device 48 that is designed as an interior camera of the motor vehicle 12. The occupant 30, 31 of the motor vehicle 12 may be detected by way of the sensor device 48 by virtue of sensor data describing him being measured by the sensor device 48. The measured sensor data may be evaluated by way of the evaluation unit 18, for example, using an identification criterion in order to generate an authorization signal. Depending on the generated authorization signal, the setting up of the communication link 26 between the data storage device 20, 21 and the vehicle computing device 14 is authorized or possibly prevented.

As an alternative to the described USB data carrier as data storage device 20, another mobile electronic appliance may alternatively serve as data storage device 20, for example a memory card and/or a mobile telephone. As an alternative to the described data storage device 21 in the form of a storage unit of a computer cloud infrastructure, the data storage device 21 may be designed as an alternative storage unit arranged outside the motor vehicle 12, such as for example as a storage unit of a computer network and/or as a storage unit of a server device.

The vehicle computing device 14 may be designed so as to be decoupled from a control device of the motor vehicle 12. However, as an alternative thereto, it may be part of a central vehicle computing device 14 of the motor vehicle 12.

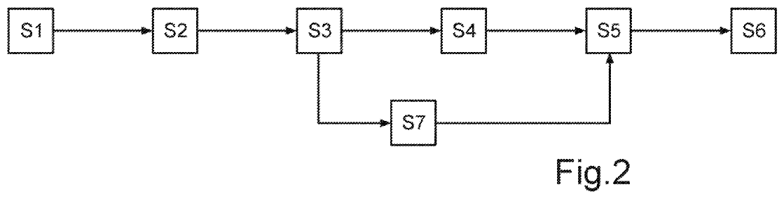

FIG. 2 shows a method for running the computer system 10 for the motor vehicle 12. In S1, a motor vehicle-related activation event is in this case ascertained for running operating system installation data, stored on the data storage device 20, 21, as a VM on the vehicle computing device 14. This takes place on the basis of activation indicator data, acquired by way of the acquisition device 16, 17, by way of the evaluation unit 18. The acquisition device 16, 17 in this case acquires, as activation indicator data, data that may describe one of the following situations: actuation of an activation element on the touch-sensitive screen 32 or on the display device 34 in combination with the actuation device 36 in order to start running the VM (as outlined for the occupant 30), occupancy of the corresponding vehicle seat in the motor vehicle 12, for example established using a corresponding weighing sensor as acquisition device 17 (as outlined for the occupant 31), unlocking of a door-locking device of the motor vehicle 12 and/or an opening of a vehicle door of the motor vehicle 12 when the VM is not running.

As soon as the motor vehicle-related activation event has been ascertained on the basis of the corresponding activation indicator data, the operating system installation data stored on the data storage device 20, 21 are received in S2. Thus, the corresponding operating system installation data are transferred from the USB data carrier as data storage device 20 and/or from the storage device of the computer cloud infrastructure as data storage device 21 to the vehicle computing device 14 for the communication link 26. In S3, the running of the VM is then started by way of the vehicle computing device 14. The virtualization software 42 of the vehicle computing device 14 is used.

In S4, a motor vehicle-related deactivation event is ascertained for running the VM on the vehicle computing device 14. This takes place on the basis of deactivation indicator data, acquired by way of the acquisition device 16, 17, by way of the evaluation unit 18. The acquisition device 16, 17 acquires, as deactivation indication data, data that describe at least one of the following situations: actuation of a deactivation element in order to end running of the VM (as may be the case for example with the occupant 30 on the touch-sensitive screen 32 and/or for the occupant 31 through corresponding actuation of the actuation device 36), non-actuation of an operating element for running the running VM for a predefined minimum period of time, non-occupancy of the vehicle seat in the motor vehicle 12, locking of a door-locking device of the motor vehicle 12 and/or opening of a vehicle door of the motor vehicle 12 when the virtual machine is running. For example, if the occupant 31 leaves the motor vehicle 12, this is recorded by the acquisition device 17 in the rear seat 15, whereupon this may be evaluated as a motor vehicle-related deactivation event.

In S5, as soon as the deactivation event has been ascertained, operating system installation data describing a current operating state of the VM are then transferred to the data storage device 20, 21. This is performed by way of the vehicle computing device 14. In this case, S5 may be performed using the data synchronization software 44. There is therefore a kind of backup of the current state of the VM. In S6, after the deactivation event has been ascertained and the operating system installation data describing the current operating system state of the VM have been transferred, the running of the VM is ended by virtue of it being shut down.

As an alternative or in addition to transferring the operating system installation data describing the current operating state of the VM to the data storage device 20, 21, these data may be transferred to a storage apparatus of the vehicle computing device 14. From there, the operating system installation data may be reloaded upon a new activation event if the occupant 30, 31 has stopped working in the meantime and there is therefore no more up-to-date state than the saved state. A corresponding checking operation may take place after the activation event has been ascertained in S1, wherein, in the case of stored operating system installation data in the storage apparatus, these are loaded, specifically instead of or in addition to loading the operating system installation data from the data storage device 20, 21.

During running of the VM, that is to say for example after S3, provision may additionally be made for the operating system installation data describing the current operating state of the VM to be transferred to the data storage device 20, 21 at least at a predetermined data synchronization time. This is illustrated at S7. This data synchronization time is reached for example at intervals after the VM is started, typically every ten minutes, such that after the VM starts running in S3, such a data transfer from the vehicle computing device 14 to the data storage device 20, 21 takes place every ten minutes. As an alternative to the cited data synchronization time, this may be reached every two minutes, three minutes, five minutes, 15 minutes, 20 minutes, 30 minutes, 45 minutes, 60 minutes, 90 minutes or 120 minutes.

Overall, the examples show the use of a VM in a motor vehicle 12. The occupant 30, 31 in this case uses hardware fixedly installed in the motor vehicle 12 in the form of the vehicle computing device 14, that is to say a computing unit, a working memory and input options, such as the touch-sensitive screen 32, the display device 34 and/or the actuation device 36 of the vehicle computing device, to work and/or play computer games. However, he does not use any operating system fixedly installed in the motor vehicle 12 in the process, but instead provides his own operating system installation, which he either carries around on an external data carrier, that is to say a mobile electronic appliance as data storage device 20, such as a hard drive, a USB stick, a memory card and/or a mobile telephone, or which he is able to download from a cloud platform accessible to him, that is to say from a storage unit of a computer cloud infrastructure as data storage device 21. The corresponding operating system installation data are stored and transferred in encrypted form in this case so that they are able to be used only by the occupant. In this context, it may be advantageous to integrate further vehicle systems for identifying the occupant 30, 31, as is possible for example through image recognition using the interior camera as sensor device 48 of the motor vehicle 12. As an alternative thereto, this occupant identification may be carried out using an identification by way of a vehicle key that is carried around. In this case, coupling to a possibly already existing user account of the occupant 30, 31 may take place.

Technically, virtualization technology in the form of the virtualization software 42 according to the related art may be used here. The operating system installation of the occupant 30, 31 is therefore available as a VM in the motor vehicle 12, which is then executed on the vehicle computing device 14 of the motor vehicle 12 via corresponding interfaces. The corresponding interface is designed here as a communication link 26 between the communication interface 22 of the vehicle computing device 14 and either the data storage device interface 24 or the communication interface 22 of the storage unit of the computer cloud infrastructure.

When leaving the motor vehicle 12, the state of the VM is stored on the data storage device 20, 21, that is to say synchronized either on the USB stick or in the cloud. The occupant 30, 31 may then for example continue working or continue playing with the same VM that he was previously running in the motor vehicle 12 in the office or at home. The occupant 30, 31 thus simply inserts his USB data carrier as data storage device 20 into the motor vehicle 12, for example, or carries out a cloud synchronization, which advantageously runs in the background, in order to avoid waiting times, and may immediately continue working at home, for example. A method such as what is known as the snapshot method of the working memory, which is performed using the data synchronization software 44, makes it possible for the operating system of the VM not to have to be shut down and restarted, but instead a change of workplace may take place during ongoing operation.

The described sequence provides the motor vehicle 12 with synchronized VM files, that is to say the operating system installation data, or snapshot files. These files may then be executed by the vehicle computing device 14 which is designed accordingly to be run in the motor vehicle 12 and is fixedly installed in the motor vehicle 12. The synchronization component takes place in this case via the link to the USB data carrier as data storage device 20 and/or via a radio link, and thus a wireless link to the storage device of the computer cloud infrastructure as data storage device 21.

If multiple occupants 30, 31 select a respective VM on their respective data storage device 20, 21, a selection may first be made on the display device 34, via the touch-sensitive screen 32, as to which operating system installation data should be executed in each case. It is additionally possible for multiple VMs to be executed simultaneously, these possibly being assigned to multiple occupants 30, 31. One application in this case is a shuttle in which multiple occupants 30, 31 use their respective VM. In this case, however, only one vehicle computing device 14 is required, which, however, has a correspondingly larger working memory and has the hypervisor 46 at its disposal.

Suitable input and output options are also reserved in the motor vehicle 12 and contained in the computer system 10. A wireless keyboard, a wireless computer mouse, a corresponding storage option, for example for a bag in the interior of a motor vehicle, a wireless touchscreen, that is to say the touch-sensitive screen 32, a tablet computer and/or a pure screen may be provided as a display device 34, which is arranged for example on a flexible swivel arm, in the motor vehicle 12. Provision may also be made to output sounds via the loudspeaker device 40 installed in the motor vehicle 12.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-13. (canceled)

14. A method of operating a computer system for a motor vehicle, the computer system including a vehicle computing device fixedly installed in the motor vehicle, an acquisition device, an evaluation unit and a removable data storage, the method comprising:
ascertaining, by the evaluation unit, a motor vehicle-related activation event for running operating system installation data stored on the data storage device as a virtual machine on the computer system based on activation indicator data, acquired by the acquisition device;
when the motor vehicle-related activation event has been ascertained, receiving the operating system installation data stored on the data storage device and starting running of the virtual machine by the vehicle computing device;
ascertaining, by the evaluation unit, a motor vehicle-related deactivation event for running the virtual machine on the vehicle computing device based on deactivation indicator data, acquired by the acquisition device;
when the motor vehicle-related deactivation event has been ascertained, transferring operating system installation data describing a current operating system state of the virtual machine to the data storage device and a storage apparatus of the vehicle computing device by the vehicle computing device;
erasing the data stored in the storage apparatus of the vehicle computing device at least one of when the data have not been accessed for a predefined period of time and when storage space in the storage apparatus drops below a predefined minimum storage space value; and
upon a next activation event, selecting between transferring new operating system installation data from the data storage device, and loading at least some of the operating system installation data from the storage apparatus.

15. The method as claimed in claim 14, further comprising, after the motor vehicle-related deactivation event has been ascertained and the operating system installation data describing the current operating system state of the virtual machine have been transferred, ending the running of the virtual machine.

16. The method as claimed in claim 15, further comprising:
running, by virtualization software included in the vehicle computing device, the received operating system installation data as a virtual machine.

17. The method as claimed in claim 16, further comprising:
generating, by data synchronization software in the vehicle computing device, the operating system installation data describing the current operating system state of the virtual machine to be transmitted to the data storage device and/or the storage apparatus.

18. The method as claimed in claim 17, further comprising:
transferring the operating system installation data describing the current operating state of the virtual machine during the running of the virtual machine at at least one predefined data synchronization time.

19. The method as claimed in claim 18, further comprising:
acquiring, by the acquisition device as activation indicator data, data that describe at least one or more of:
actuation of an activation element in order to start running of the virtual machine;
coupling of the data storage device comprising the stored operating system installation data to a data storage device interface of the motor vehicle;
a successful login process with a predefined user account;
unlocking of a door-locking device of the motor vehicle;
opening of a vehicle door of the motor vehicle when the virtual machine is not running; and
occupancy of a vehicle seat in the motor vehicle when the virtual machine is not running.

20. The method as claimed in claim 19, further comprising:
acquiring, by the acquisition device as deactivation indicator data, data that describe at least one or more of:
actuation of a deactivation element in order to end running of the virtual machine;
a successful logout process with a predefined user account;
non-actuation of an operating element for running the running virtual machine for a predefined minimum period of time;
locking of a door-locking device of the motor vehicle;
opening of a vehicle door of the motor vehicle when the virtual machine is running; and
non-occupancy of a vehicle seat in the motor vehicle.

21. The method as claimed in claim 20, further comprising:
acquiring sensor data describing an occupant of the motor vehicle by a sensor device of the motor vehicle; and
evaluating the acquired sensor data by the evaluation unit using an identification criterion to generate an authorization signal, wherein the setting of the communication link between the data storage device and the vehicle computing device is permitted or prevented by the vehicle computing device depending on the generated authorization signal.

22. The method as claimed in claim 21, wherein the vehicle computing device comprises a hypervisor, the method further comprising:
running multiple virtual machines on the vehicle computing device at the same time when the vehicle computing device is provided with respective operating system installation data by multiple data storage devices.

23. The method as claimed in claim 22, further comprising:
running, by virtualization software included in the vehicle computing device, the received operating system installation data as a virtual machine.

24. The method as claimed in claim 23, further comprising:
generating, by data synchronization software in the vehicle computing device, the operating system installation data describing the current operating system state of the virtual machine to be transmitted to the data storage device and/or the storage apparatus.

25. The method as claimed in claim 24, further comprising:
transferring the operating system installation data describing the current operating state of the virtual machine during the running of the virtual machine at at least one predefined data synchronization time.

26. The method as claimed in claim 25, further comprising:
acquiring, by the acquisition device as activation indicator data, data that describe at least one or more of:
actuation of an activation element in order to start running of the virtual machine;
coupling of the data storage device comprising the stored operating system installation data to a data storage device interface of the motor vehicle;
a successful login process with a predefined user account;
unlocking of a door-locking device of the motor vehicle;
opening of a vehicle door of the motor vehicle when the virtual machine is not running; and
occupancy of a vehicle seat in the motor vehicle when the virtual machine is not running.

27. The method as claimed in claim 26, further comprising:
acquiring, by the acquisition device as deactivation indicator data, data that describe at least one or more of:
actuation of a deactivation element in order to end running of the virtual machine;
a successful logout process with a predefined user account;
non-actuation of an operating element for running the running virtual machine for a predefined minimum period of time;
locking of a door-locking device of the motor vehicle;
opening of a vehicle door of the motor vehicle when the virtual machine is running; and
non-occupancy of a vehicle seat in the motor vehicle.

28. The method as claimed in claim 27, further comprising:
acquiring sensor data describing an occupant of the motor vehicle by a sensor device of the motor vehicle; and
evaluating the acquired sensor data by the evaluation unit using an identification criterion to generate an authorization signal, wherein the setting of the communication link between the data storage device and the vehicle computing device is permitted or prevented by the vehicle computing device depending on the generated authorization signal.

29. The method as claimed in claim 28, wherein the vehicle computing device comprises a hypervisor, the method further comprising:
running multiple virtual machines on the vehicle computing device at the same time when the vehicle computing device is provided with respective operating system installation data by multiple data storage devices.

30. A computer system for a motor vehicle, comprising:
a vehicle computing device fixedly installed in the motor vehicle;
an acquisition device to acquire activation indicator data and deactivation indicator data;
a data storage device, not fixedly installed in the motor vehicle, configured to transfer and/or receive operating system installation data, able to be run as a virtual machine (VM) to and/or from the vehicle computing device via a communication link with the vehicle computing device; and
an evaluation unit configured to
ascertain a motor vehicle-related activation event for running operating system installation data stored on the data storage device as a virtual machine on the vehicle computing device based on the activation indicator data acquired by the acquisition device, and a motor vehicle-related deactivation event for stopping the virtual machine on the vehicle computing device based on the deactivation indicator data acquired by the acquisition device, the vehicle computing device
receiving the operating system installation data stored on the data storage device and running the virtual machine when the motor vehicle-related activation event has been ascertained,
transferring operating system installation data describing a current operating system state of the virtual machine to the data storage device and a storage apparatus of the vehicle computing device, when the motor vehicle-related activation event has been ascertained, and
automatically erasing the data stored in the storage apparatus of the vehicle computing device when at least one of the data have not been accessed for a predefined period of time and storage space in the storage apparatus drops below a predefined minimum storage space value, and
select, upon a next activation event, between transferring new operating system installation data from the data storage device and loading at least some of the operating system installation data from the storage apparatus.

31. The computer system as claimed in claim 30, wherein the data storage device comprises at least one of
a mobile electronic appliance including at least one of a Universal Serial Bus data carrier, a hard drive, a memory card and a mobile telephone; and
a storage unit outside of the motor vehicle, including at least one of a computer network, a server device and computer cloud infrastructure.

32. The computer system as claimed in claim 31, further comprising, actuated by the vehicle computing device during the running of the virtual machine, at least one of
a display device;
an actuation device;
a microphone device; and
a loudspeaker device.

33. The computer system as claimed in claim 32, wherein the vehicle computing device is a computer decoupled from a control device of the motor vehicle.
